(19) United States
(12) Patent Application Publication
(10) Pub. No.: US 2025/0081060 A1
(43) Pub. Date: Mar. 6, 2025

(54) MEASUREMENT PROCEDURE FOR CONDITIONAL CELL CHANGE IN A NON-TERRESTRIAL NETWORK (NTN)

(71) Applicant: Telefonaktiebolaget LM Ericsson (publ), Stockholm (SE)

(72) Inventors: Ming LI, Stockholm (SE); Muhammad Ali KAZMI, Reston, VA (US)

(21) Appl. No.: 18/725,979

(22) PCT Filed: Dec. 27, 2022
(86) PCT No.: PCT/SE2022/051241

§ 371 Date: Jul. 1, 2024

Related U.S. Application Data
(60) Provisional application No. 63/296,658, filed on Jan. 5, 2022.

(51) Int. Cl. H04W 36/08; H04W 36/00

(52) U.S. Cl. CPC H04W 36/083; H04W 36/0088; H04W 36/0094

(57) ABSTRACT

A method, network node and wireless device (WD) for measurement procedures for conditional cell change in a non-terrestrial network (NTN) are disclosed. According to one aspect, a method in a WD includes performing a first measurement procedure on one or more satellite cells of a plurality of satellite cells when the WD is in a first cell change procedure state and performing a second measurement procedure on one or more satellite cells of the plurality of satellite cells when the WD is in a second cell change procedure state, the first and second cell change procedure states being based at least in part on at least one of a distance between the WD and at least one satellite of the plurality of satellites and a time of coverage of the at least one satellite of the plurality of satellites.

### TECHNICAL FIELD

The present disclosure relates to wireless communications, and in particular, to measurement procedures for conditional cell change in a non-terrestrial network (NTN).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

In 3GPP, 5G systems are intended to serve use cases such as enhanced mobile broadband (eMBB), ultra-reliable and low latency communication (URLLC), and mMTC. 5G includes the New Radio (NR) access stratum interface and the 5G Core Network (5GC). The NR physical and higher layers reuse parts of the LTE specification, and to that add components when motivated by new use cases. To benefit from the strong mobile ecosystem and economy of scale, a satellite network based on the terrestrial wireless access technologies including LTE and NR for satellite networks, is being specified in the 3GPP standard.

### Characteristics

A satellite radio access network usually includes the following components:
A satellite that refers to a space-borne platform;
An earth-based gateway that connects the satellite to a base station or a core network, depending on the choice of architecture;
A feeder link that refers to the link between a gateway and a satellite; and
An access link, or service link, that refers to the link between a satellite and a WD.

Depending on the orbit altitude, a satellite may be categorized as low earth orbit (LEO), medium earth orbit (MEO), or geostationary earth orbit (GEO) satellite:
LEO: typical heights ranging from 250-1,500 km, with orbital periods ranging from 90-120 minutes;
MEO: typical heights ranging from 5,000-25,000 km, with orbital periods ranging from 3-15 hours; and
GEO: height at about 35,786 km, with an orbital period of 24 hours.

Two basic architectures can be distinguished for satellite communication networks, depending on the functionality of the satellites in the system:
Transparent payload (also referred to as bent pipe architecture).

The satellite forwards the received signal between the terminal and the network equipment on the ground with only amplification and a shift from uplink frequency to downlink frequency. When applied to general 3GPP architecture and terminology, the transparent payload architecture means that the network node is located on the ground and the satellite forwards signals/data between the network node and the WD; and
Regenerative payload. The satellite includes on-board processing to demodulate and decode the received signal and regenerate the signal before sending it back to the earth. When applied to general 3GPP architecture and terminology, the regenerative payload architecture means that the network node is located in the satellite.

Only the transparent payload architecture is considered in the work item for NR NTN in 3GPP Release 17 (3GPP Rel-17).

A satellite network or satellite based mobile network may also be referred to as a non-terrestrial network (NTN). On the other hand, a mobile network with base stations on the ground may be referred to as a terrestrial network (TN) or non-NTN network. A satellite within am NTN may be referred to as a NTN node, NTN satellite or simply a satellite.

FIG. 1 shows an example architecture of a satellite network with bent pipe transponders (i.e., the transparent payload architecture).

A communication satellite typically generates several beams over a given area. The footprint of a beam is usually in an elliptic shape, which has traditionally been referred to as a cell, but cells that consist of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is an expensive and time-consuming procedure. It is therefore expected that all LEO and MEO satellite constellations for some time will only provide partial earth-coverage. In case of some constellations dedicated to massive Internet of things (IoT) services with relaxed latency requirements, it may not be necessary to support full earth-coverage. It may be sufficient to provide occasional or periodic coverage according to the orbital period of the constellation of satellites.

A 3GPP device in RRC_IDLE or RRC_INACTIVE state is required to perform a number of procedures including measurements for mobility purposes, paging monitoring, logging measurement results, tracking area update, and search for a new public land mobile network (PLMN), to mention a few. These procedures will consume power in devices, and a general trend in 3GPP has been to allow for relaxation of these procedures to prolong device battery life. This trend has been especially pronounced for IoT devices supported by reduced capability (redcap), NB-IoT and LTE-M.

Propagation delay is an aspect of satellite communications that is different from the delay expected in a terrestrial mobile system. For a bent pipe satellite network, the round-trip delay may, depending on the orbit height, range from tens of milliseconds (ms) in the case of LEO satellites to several hundreds of ms for GEO satellites. As a comparison, the round-trip delays in terrestrial cellular networks are typically below 1 ms.

The distance between the WD and a satellite can vary significantly, depending on the position of the satellite and the elevation angle F seen by the WD. Assuming circular orbits, the minimum distance is realized when the satellite is directly above the WD (ε=90°), and the maximum distance when the satellite is at the smallest possible elevation angle. Table 1 shows the distances between satellite and WD for different orbital heights and elevation angles together with the one-way propagation delay and the maximum propagation delay difference (the difference from the propagation delay at ε=90°). Note that this table assumes a regenerative payload architecture. For the transparent payload case, the propagation delay between gateway and satellite needs to be considered as well, unless the base station corrects for that.

TABLE 1
Propagation delay for different orbital heights and elevation angles

| | | | Distance | | One-way | | Propagation | |
|---|---|---|---|---|---|---|---|---|
| Orbital | | Elevation | WD <-> | | propagation | | delay | |
| height | | angle | satellite | | delay | | difference | |
| 600 | km | 90° | 600 | km | 2.0 | ms | — | |
| | | 30° | 1075 | km | 3.6 | ms | 1.6 | ms |
| | | 10º | 1932 | km | 6.4 | ms | 4.4 | ms |
| 1200 | km | 90° | 1200 | km | 4.0 | ms | — | |
| | | 30° | 1999 | km | 6.7 | ms | 2.7 | ms |
| | | 10° | 3131 | km | 10.4 | ms | 6.4 | ms |
| 35786 | km | 90° | 35786 | km | 119.4 | ms | — | |
| | | 30° | 38609 | km | 128.8 | ms | 9.4 | ms |
| | | 10° | 40581 | km | 135.4 | ms | 16.0 | ms |

The propagation delay may also be highly variable due to the high velocity of the LEO and MEO satellites and may change by 10-100 μs every second, depending on the orbit altitude and satellite velocity.

### Ephemeris Data

In 3GPP Technical Release (TR) 38.821, ephemeris data should be provided to the WD, for example to assist with pointing a directional antenna (or an antenna beam) towards the satellite. A WD knowing its own position, e.g., using global navigation satellite system (GNSS) support, may also use the ephemeris data to calculate correct for timing and/or frequency drifts, e.g., Timing Advance (TA) and Doppler shift. The contents of the ephemeris data and the procedures on how to provide and update such data have not yet been studied in detail.

A satellite orbit can be fully described using 6 parameters. Exactly which set of parameters is used can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g., the time when the satellites moves through periapsis). The set of these parameters is illustrated in the example of FIG. 2.

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vₓ, v_{y}, v_{z}) of a satellite. These are sometimes called orbital state vectors. They can be derived from the orbital elements and vice versa since the information they contain is equivalent. All these formulations (and many others) are possible choices for the format of ephemeris data to be used in NTN.

Additionally, the ephemeris data may be accompanied with information on possible coverage area, or timing information concerning when the satellite is going to serve a certain geographical area on Earth.

### SSB-MTC and Measurement Gaps

A NR synchronization signal (SS) consists of primary SS (PSS) and secondary SS (SSS). A NR physical broadcast channel (PBCH) carries basic system information. The combination of SS and PBCH is referred to as a synchronization signal block (SSB) in NR. Multiple SSBs are transmitted in a localized burst set. Within an SS burst set, multiple SSBs can be transmitted in different beams. The transmission of SSBs within a localized burst set is confined to a 5 ms window. The set of possible SSB time locations within an SS burst set depends on the numerology, which in most cases is uniquely identified by the frequency band. The SSB periodicity can be configured from the value set {5, 10, 20, 40, 80, 160}ms (where the unit used in the configuration is a subframe, which has a duration of 1 ms).

A WD does not need to perform measurements with the same periodicity as the SSB periodicity. Accordingly, the SSB measurement time configuration (SMTC) has been introduced for NR. The signaling of SMTC window informs the WD of the timing and periodicity of SSBs that the WD can use for measurements. The SMTC window periodicity can be configured from the value set {5, 10, 20, 40, 80, 160}ms, matching the possible SSB periodicities. The SMTC window duration can be configured from the value set {1, 2, 3, 4, 5}ms (where the unit used in the configuration is subframe, which has a duration of 1 ms). The SMTC window duration may also be called the SMTC duration or SMTC occasion or length in time.

The WD may use the same RF module for measurements of neighboring cells and data transmission in the serving cell. Measurement gaps allow the WD to suspend the data transmission in the serving cell and perform the measurements of neighboring cells. The measurement gap repetition periodicity can be configured from the value set {20, 40, 80, 160}ms and the gap length can be configured from the value set {1.5, 3, 3.5, 4, 5.5, 6, 10, 20}ms. Usually, the measurement gap length is configured to be larger than the SMTC window duration to allow for RF retuning time. Measurement gap time advance is also introduced to fine tune the relative position of the measurement gap with respect to the SMTC window. The measurement gap timing advance can be configured from the value set {0, 0.25, 0.5} ms.

FIG. 3 provides an example illustration of SSB, SMTC window, and measurement gap.

The following challenges exist in an NTN: moving satellites (resulting in moving cells or switching cells) and long propagation delays, both of which are discussed as follows.

Moving satellites (resulting in moving or switching cells): The default assumption in terrestrial network design, e.g., NR or LTE, is that cells are stationary. This is not the case in NTN, especially when LEO satellites are considered. A LEO satellite may be visible to a WD on the ground only for a few seconds or minutes. There are two different options for LEO deployment. The beam/cell coverage is fixed with respect to a geographical location with earth-fixed beams, i.e., steerable beams from satellites ensure that a certain beam covers the same geographical area even as the satellite moves in relation to the surface of the earth. On the other hand, with moving beams, a LEO satellite has fixed antenna pointing direction in relation to the earth's surface, e.g., perpendicular to the earth's surface, and thus, cell and beam coverage sweeps the earth as the satellite moves. In that case, the spotbeam that serves the WD may switch every few seconds.

Long propagation delays: The propagation delays in terrestrial mobile systems are usually less than 1 millisecond. In contrast, the propagation delays in NTN can be much longer, ranging from several milliseconds (LEO) to hundreds of milliseconds (GEO) depending on the altitudes of the spaceborne or airborne platforms deployed in the NTN.

The following have been considered to support time assisted cell reselection:
1. For quasi-earth fixed cell, WD should start measurements on neighbor cells before the serving cell stops covering the current area;
2. For quasi-earth fixed cell, the broadcast “timing information on when a cell is going to stop serving the area” refers to the time when a cell stops covering the current area; and
3. For quasi-earth fixed cell, the WD should start measurements on neighbor cells before the broadcast stop time of the serving cell, i.e., the time when the serving cell stops covering the current area, and the exact time to start measurements is up to WD implementation.

The point is that the stop time of the serving cell can be broadcast to assist the WD to perform measurements on neighbor cells. Meanwhile, there is also a working assumption to further consider location-assisted cell reselection.

### Working Assumption:

Location assisted cell reselection, with the distance between WD and the reference location of the cell (serving cell and/or neighbor cell) taken into account, is supported for a quasi-earth fixed cell, if WD has valid location information. This means location acquisition will not be triggered at the WD only for location assisted cell reselection.

Both conditional handoff (CHO) and radio resource management (RRM) location reporting event triggers are considered jointly as earlier concluded by RAN2. Related considerations from RAN2113:

### Considerations:

The location in location-based CHO execution triggering for NTN describes the distance between the WD and the reference location of the cell (serving cell or the target cell). For future study (FFS): what the reference location of the cell is (e.g., cell center or other) and how this is provided to the WD.

Related Considerations from RAN2114:

Support CHO location trigger as the distance between the WD and a reference location which may be configured as the serving cell reference location or the candidate target cell reference location. It remains to be considered whether the combination is allowed.

The reference location for the event description is defined as the cell center.

Related Considerations from RAN2 #113:

### Considered:

1. Timing information in CHO execution triggering for NTN describes the time after which the WD is allowed to execute CHO to the candidate target cell; and
2. Working assumption: the timing information for CHO execution triggering in NTN is defined in the form of a timer/timers. This can be revised and a solution based on coordinated universal time (UTC)/system frame number can be considered if problems are found (e.g., if the timer lacks accuracy due to round trip time (RTT) in NTN).
   Related Considerations from RAN2 #114:
Via email (from offline 104−second round):

The CHO time trigger event is defined as time duration [t1, t2] associated for each CHO candidate cell. The WD shall execute CHO to that candidate cell during the time duration, if all other configured CHO execution conditions will apply and there is only one triggered candidate cell.

Regarding RAN2's consideration on time, location assistance to reselection and CHO, the WD is allowed to measure, evaluate and operate reselection and CHO with time and/or location assistance. But the measurement procedure is not specified with respect time and location information. A further concern is flexibility and robustness.

### SUMMARY

Some embodiments advantageously provide methods, network nodes, and WDs for measurement procedures for conditional cell change in a non-terrestrial network (NTN).

In some embodiments, a mechanism is provided for the WD in a NTN (e.g., WD served by an NTN node) to adaptively adjust measurement procedures (e.g., measurement rate, number, periodicity, duration, total number of carriers/frequencies/cells to be measured, etc.) based on time and/or location assistance information when the WD is configured to perform a cell change (CC), e.g., a conditional cell change, conditional handover (CHO), cell reselection, etc.

In some embodiments, the configured CC procedure of the WD may be in one of two states or time phases at any time during the cell change procedure: the S1 state or the S2 state. The measurement procedure applied by the WD may depend on whether the configured CC is in the S1 state or the S2 state.

In some embodiments, the configured CC procedure may be in the S1 state when a serving cell has a time that is longer than or equal to certain threshold (Ht11) to provide service before it expires. But the configured CC procedure may be in the S2 state when there is a time that is shorter than the threshold (Ht11) before the serving cell expires.

In some embodiments, the configured CC procedure may be in the S1 state before satellites for serving or neighbor cells arrive at certain relative positions, e.g., the distance between WD and the serving cell's satellite is below or equal to a first threshold (H11) and the distance between WD and certain neighbor cell's satellite is above a second threshold (H12). But the configured CC procedure may be in state S2 after satellites for serving or neighbor cells arrive at other relative positions, e.g., when the distance with respect to serving satellite is >H11, and/or the distance with respect to a neighbor satellite is <=H12, then the WD is in state S2. In the S1 state, the WD may use a first measurement procedure (P1) for performing one or more measurements on one or more cells and in the S2 state the WD may use a second measurement procedure (P2) for performing one or more measurements on one or more cells.

In some embodiments, enhancement on measurements include adjustments on measurement procedure (e.g., measurement rate, number, periodicity, duration, total number of carriers/frequencies/cells to be measured, etc.); measurement procedure (P2); non-enhancement or regular measurements include adjustments on measurement procedure (e.g., measurement rate, number, periodicity, duration, total number of carriers/frequencies/cells to be measured etc.) measurement procedure (P1). A difference between parameters in P1 and P2 may be pre-defined or configured by the network node.

In some embodiments, the network node indicates to the WD whether the configured CC is in the S1 state or in the S2 state, with respect to time and/or location assistance information and signal strength/quality of the serving cell and/or neighbor cells.

In some embodiments, an alternative approach is that the WD is configured to evaluate one or more criteria based on time and/or location assistance information and signal strength/quality of serving cell and/or neighbor cells and based on the evaluation, the WD determines whether the configured CC is in the S1 state or in the S2 state.

In some embodiments, the WD may indicate to the network node the capability to support S1/S2 and/or information in P1/P2.

Some embodiments provide solutions for the WD in an NTN (e.g., a WD served by an NTN node) to adaptively adjust measurement procedures based on a time and/or location assistance information.

Some embodiments, enable conservation of power of the WD in an NTN and support mobility with less delay when needed.

According to one aspect, a method in a WD configured to communicate with a network node and a plurality of satellites on a corresponding plurality of satellite cells includes: performing a first measurement procedure on one or more satellite cells of the plurality of satellite cells when the WD is in a first cell change procedure state and performing a second measurement procedure on one or more satellite cells of the plurality of satellite cells when the WD is in a second cell change procedure state, the first and second cell change procedure states being based at least in part on at least one of a distance between the WD and at least one satellite of the plurality of satellites and a time of coverage of the at least one satellite of the plurality of satellites.

According to this aspect, in some embodiments, the first measurement procedure is configured with a first number, periodicity and duration of measurements and the second measurement procedure is configured with a second number, periodicity and duration of measurements. In some embodiments, the first cell change procedure state is configured when a satellite serving cell of the plurality of satellite cells has a first time duration of coverage that exceeds a first threshold and the second cell change procedure state is configured when the satellite serving cell has a second time duration of coverage that falls below a second threshold. In some embodiments, the first cell change procedure state is configured when at least one of a first distance between the WD and a first satellite of the plurality of satellites falls below a first threshold and a second distance between the WD and a second satellite of the plurality of satellites exceeds a second threshold; and the second cell change procedure state is configured when at least one of a first distance between the WD and a first satellite of the plurality of satellites exceeds a first threshold and a second distance between the WD and a second satellite of the plurality of satellites falls below a second threshold. In some embodiments, the method also includes receiving from the network node an indication of one of the first cell change procedure state and the second cell change procedure state. In some embodiments, the method also includes measuring a satellite signal of a satellite of the plurality of satellites and selecting one of the first measurement procedure and the second measurement procedure based at least in part on the measurement of the satellite signal. In some embodiments, the method includes indicating to the network node a capability to support the first and second cell change procedure states. In some embodiments, the first cell change procedure state is configured for a first time duration and the second cell change procedure state is configured for a second time duration at a later time than the first time duration. In some embodiments, the method includes performing a cell change from a first satellite cell of the plurality of satellite cells to a second satellite cell of the plurality of satellite cells during the second time duration. In some embodiments, the method includes performing a cell change from a first satellite cell of the plurality of satellite cells to a second satellite cell of the plurality of satellite cells during the first time duration. In some embodiments, the cell change includes one or more of: a cell reselection, a handover, a conditional cell change, a conditional handover and a conditional radio resource control, RRC, connection release with redirection.

According to another aspect, WD configured to communicate with a network node and a plurality of satellites on a corresponding plurality of satellite cells includes: performing a first measurement procedure on one or more satellite cells of the plurality of satellite cells when the WD is in a first cell change procedure state and performing a second measurement procedure on one or more satellite cells of the plurality of satellite cells when the WD is in a second cell change procedure state, the first and second cell change procedure states being based at least in part on at least one of a distance between the WD and at least one satellite of the plurality of satellites and a time of coverage of at least one satellite of the plurality of satellites.

According to this aspect, in some embodiments, the first measurement procedure is configured with a first number, periodicity and duration of measurements and the second measurement procedure is configured with a second number, periodicity and duration of measurements. In some embodiments, the first cell change procedure state is configured when a satellite serving cell of the plurality of satellite cells has a first time duration of coverage that exceeds a first threshold and the second cell change procedure state is configured when the satellite serving cell has a second time duration of coverage that falls below a second threshold. In some embodiments, the first cell change procedure state is configured when at least one of a first distance between the WD and a first satellite of the plurality of satellites falls below a first threshold and a second distance between the WD and a second satellite of the plurality of satellites exceeds a second threshold; and the second cell change procedure state is configured when at least one of a first distance between the WD and a first satellite of the plurality of satellites exceeds a first threshold and a second distance between the WD and a second satellite of the plurality of satellites falls below a second threshold. In some embodiments, the wireless device further includes a radio interface in communication with the processing circuitry and configured to receive from the network node an indication of one of the first cell change procedure state and the second cell change procedure state. In some embodiments, the processing circuitry is further configured to measure a satellite signal of a satellite of the plurality of satellites and selecting one of the first measurement procedure and the second measurement procedure based at least in part on the measurement of the satellite signal. In some embodiments, the processing circuitry is further configured to indicate to the network node a capability to support the first and second cell change procedure states. In some embodiments, the first cell change procedure state is configured for a first time duration and the second cell change procedure state is configured for a second time duration at a later time than the first time duration. In some embodiments, the processing circuitry is further configured to perform a cell change from a first satellite cell of the plurality of satellite cells to a second satellite cell of the plurality of satellite cells during the second time duration. In some embodiments, the processing circuitry is further configured to perform a cell change from a first satellite cell of the plurality of satellite cells to a second satellite cell of the plurality of satellite cells during the first time duration. In some embodiments, the cell change includes one or more of: a cell reselection, a handover, a conditional cell change, a conditional handover and a conditional RRC connection release with redirection.

According to another aspect, a method in a network node configured to communicate with a wireless device, WD, the WD being configured to communicate on a least one of a plurality of satellite cells of a corresponding plurality of satellites includes configuring the WD with one of a first cell change procedure state and a second cell change procedure state based at least in part on at least one of a distance between the WD and at least one satellite of the plurality of satellites and a time of coverage of the at least one satellite of the plurality of satellites.

According to this aspect, in some embodiments, the method includes configuring the WD to perform a first measurement procedure in the first cell change procedure state and to perform a second measurement procedure in the second cell change procedure state. In some embodiments, the first cell change procedure state is configured when a satellite serving cell of the plurality of satellite cells has a first time duration of coverage that exceeds a first threshold and the second cell change procedure state is configured when the satellite serving cell has a second time duration of coverage that falls below a second threshold. In some embodiments, the first cell change procedure state is configured when at least one of a first distance between the WD and a first satellite of the plurality of satellites falls below a first threshold and a second distance between the WD and a second satellite of the plurality of satellites exceeds a second threshold; and the second cell change procedure state is configured when at least one of a first distance between the WD and a first satellite of the plurality of satellites exceeds a first threshold and a second distance between the WD and a second satellite of the plurality of satellites falls below a second threshold. In some embodiments, the method includes configuring the WD with the first threshold and the second threshold. In some embodiments, the method includes configuring the first cell change procedure state for a first time duration and configured the second cell change procedure state for a second time duration at a later time than the first time duration. In some embodiments, the cell change includes one or more of: a cell reselection, a handover, a conditional cell change, a conditional handover and a conditional RRC connection release with redirection.

According to another aspect, a network node configured to communicate with a wireless device, WD, the WD being configured to communicate on a least one of a plurality of satellite cells of a corresponding plurality of satellites. The network node includes processing circuitry configured to: configure the WD with one of a first cell change procedure state and a second cell change procedure state based at least in part on at least one of a distance between the WD and at least one satellite of the plurality of satellites and a time of coverage of the at least one satellite of the plurality of satellites.

According to this aspect, in some embodiments, the processing circuitry is further configured to configure the WD to perform a first measurement procedure in the first cell change procedure state and to perform a second measurement procedure in the second cell change procedure state. In some embodiments, the first cell change procedure state is configured when a satellite serving cell of the plurality of satellite cells has a first time duration of coverage that exceeds a first threshold and the second cell change procedure state is configured when the satellite serving cell has a second time duration of coverage that falls below a second threshold. In some embodiments, the first cell change procedure state is configured when at least one of a first distance between the WD and a first satellite of the plurality of satellites falls below a first threshold and a second distance between the WD and a second satellite of the plurality of satellites exceeds a second threshold; and the second cell change procedure state is configured when at least one of a first distance between the WD and a first satellite of the plurality of satellites exceeds a first threshold and a second distance between the WD and a second satellite of the plurality of satellites falls below a second threshold. In some embodiments, the processing circuitry is further configured to configure the WD with the first threshold and the second threshold. In some embodiments, the processing circuitry is further configured to configure the first cell change procedure for a first time duration and configure the second cell change procedure state for a second time duration at a later time than the first time duration. In some embodiments, the cell change includes one or more of: a cell reselection, a handover, a conditional cell change, a conditional handover and a conditional RRC connection release with redirection.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example architecture of a satellite network with bent pipe transponders;

FIG. 2 illustrates orbital parameters;

FIG. 3 illustrates an SSB, SMTC window and measurement gap;

FIG. 4 is a schematic diagram of an example network architecture illustrating a communication system according to principles disclosed herein;

FIG. 5 is a block diagram of a network node in communication with a wireless device over a wireless connection according to some embodiments of the present disclosure;

FIG. 6 is a flowchart of an example process in a network node for measurement procedures for conditional cell change in a non-terrestrial network (NTN) according to some embodiments of the present disclosure;

FIG. 7 is a flowchart of an example process in a wireless device for measurement procedures for conditional cell change in a non-terrestrial network (NTN) according to some embodiments of the present disclosure;

FIG. 8 is a flowchart of another example process in a wireless device for measurement procedures for conditional cell change in a non-terrestrial network (NTN) according to some embodiments of the present disclosure;

FIG. 9 is a flowchart of another example process in a network node for measurement procedures for conditional cell change in a non-terrestrial network (NTN) according to some embodiments of the present disclosure

FIG. 10 shows an example relationship between states and timing;

FIG. 11 is an example timeline of time-based CHO;

FIG. 12 is an example timeline of location-based CHO;

FIG. 13 is another example timeline of time-based reselection; and

FIG. 14 is another example timeline of location-based reselection.

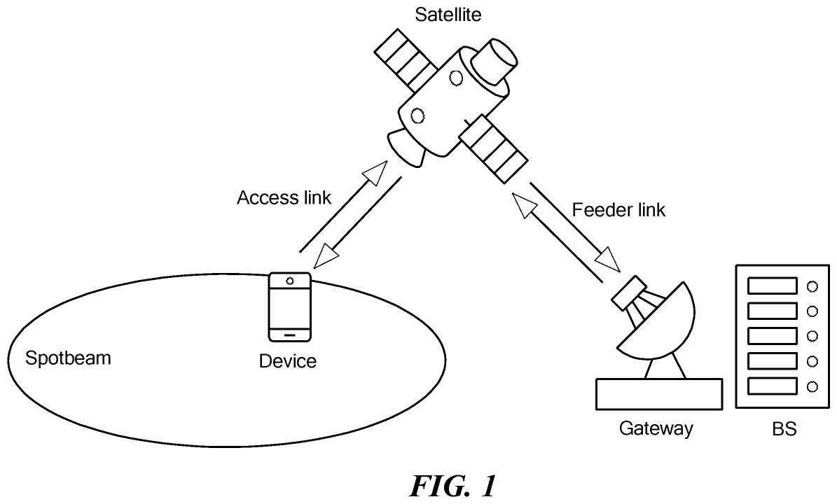

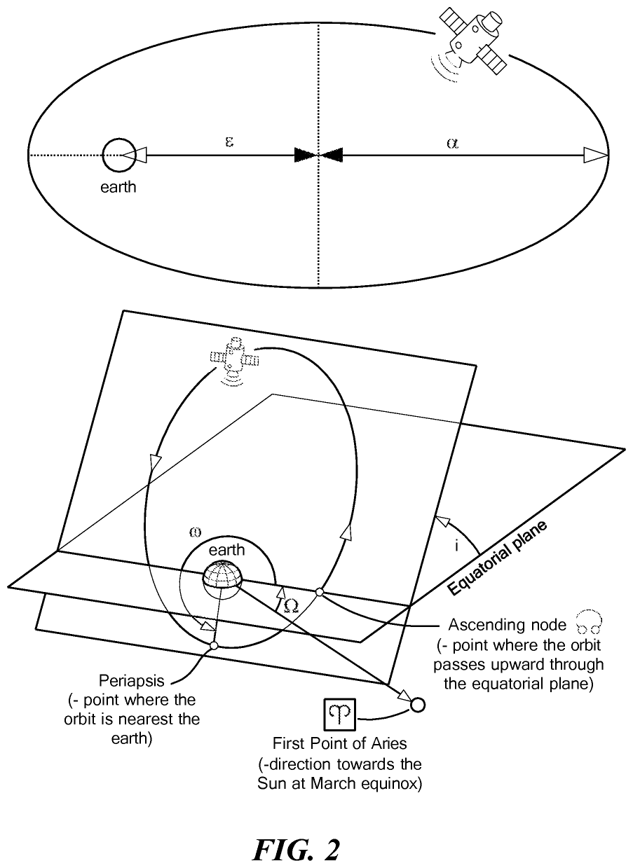

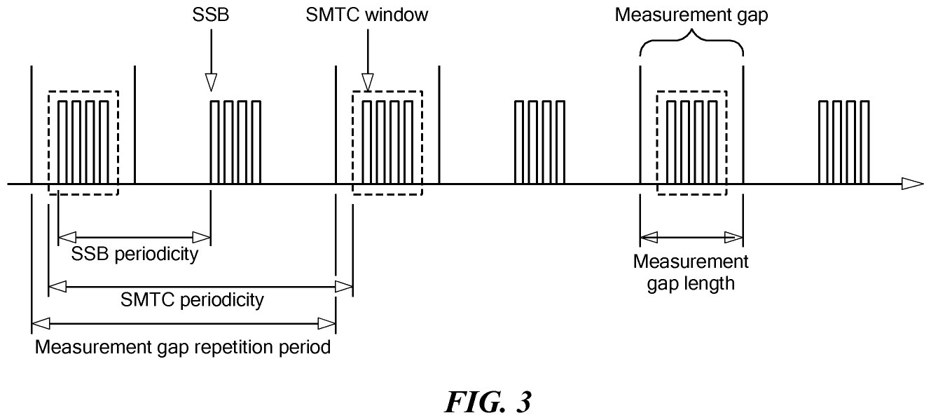

### DETAILED DESCRIPTION

Before describing in detail example embodiments, it is noted that the embodiments reside primarily in combinations of apparatus components and processing steps related to measurement procedures for conditional cell change in a non-terrestrial network (NTN). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

The term node may refer to a network node or a wireless device (WD). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME, etc.), O&M, OSS, SON, positioning node (e.g., E-SMLC), etc.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc. Thus, examples of WDs are target device, device to device (D2D) WD, vehicular to vehicular (V2V), machine type WD, MTC WD or WD capable of machine to machine (M2M) communication, PDA, tablet, mobile terminals, smart phone, laptop embedded equipment (LEE), laptop mounted equipment (LME), USB dongles, etc.

The term “satellite” is often used when a more appropriate term might be “gNB associated with the satellite”. The term “satellite” may also be referred to as a satellite node, an NTN node, a node in the space, etc. Here, a network node associated with a satellite may include both a regenerative satellite, where the network node is the satellite payload, i.e., the network node is integrated with the satellite, or a transparent satellite, where the satellite payload is a relay and the network node is on the ground (i.e., the satellite relays the communication between the network node on the ground and the WD).

A time period or duration over which a WD may maintain a connection, or may camp on, or may maintain communication, and so on to a satellite or a network node is referred to as “coverage time” or “serving time” or “network availability” or “sojourn time” or “dwell time,” etc. The term ‘Non-coverage time’, also known as “non-serving time” or “network unavailability”, or “non-sojourn time” or “non-dwell time” refers to a period of time during which a satellite or network node cannot serve or communicate or provide coverage to a WD. Unavailability exists when the satellite or network is not able to serve the WD due to lack of coverage, but the WD does not need to measure certain signals, thereby indicating a “not likely to be serving cell (satellite via which serving cell is broadcasted)” situation. In this case, the terminology may still be the same as with the no coverage case, or the terminology may be different, e.g., “no need to measure”.

The term radio access technology, or RAT, may refer to any RAT, e.g., UTRA, E-UTRA, narrow band internet of things (NB-IoT), Wi-Fi, Bluetooth, next generation RAT, New Radio (NR), 4G, 5G, NR NTN, IoT NTN, LTE NTN, etc. Any of the equipment denoted by the term node, network node or radio network node may be capable of supporting a single or multiple RATs.

The term signal or radio signal used herein may be any physical signal or physical channel. Examples of DL physical signals are reference signal (RS) such as PSS, SSS, CSI-RS, DMRS signals in SS/PBCH block (SSB), discovery reference signal (DRS), CRS, PRS, etc. RS may be periodic, e.g., RS occasion carrying one or more RSs may occur with certain periodicity e.g. 20 ms, 40 ms, etc. The RS may also be aperiodic. Each SSB carries NR-PSS, NR-SSS and NR-PBCH in 4 successive symbols. One or multiple SSBs are transmit in one SSB burst which is repeated with certain periodicity, e.g., 5 ms, 10 ms, 20 ms, 40 ms, 80 ms and 160 ms. The WD is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to a reference time (e.g., serving cell's SFN), etc. Therefore, an SMTC occasion may also occur with certain periodicity, e.g., 5 ms, 10 ms, 20 ms, 40 ms, 80 ms and 160 ms. Examples of uplink (UL) physical signals are reference signal such as SRS, DMRS, etc. The term physical channel refers to any channel carrying higher layer information, e.g., data, control, etc. Examples of physical channels are PBCH, narrowband PBCH (NPBCH), physical downlink control channel (PDCCH), physical downlink shared channel (PDSCH), physical uplink control channel (PUCCH), sPDSCH, sPUCCH, physical uplink shared channel (PUSCH), machine-type PDCCH (MPDCCH), NPDCCH, NPDSCH, evolved PDCCH (E-PDCCH), sPUSCH, PUCCH, NPUSCH, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to measurement procedures for conditional cell change in a non-terrestrial network (NTN).

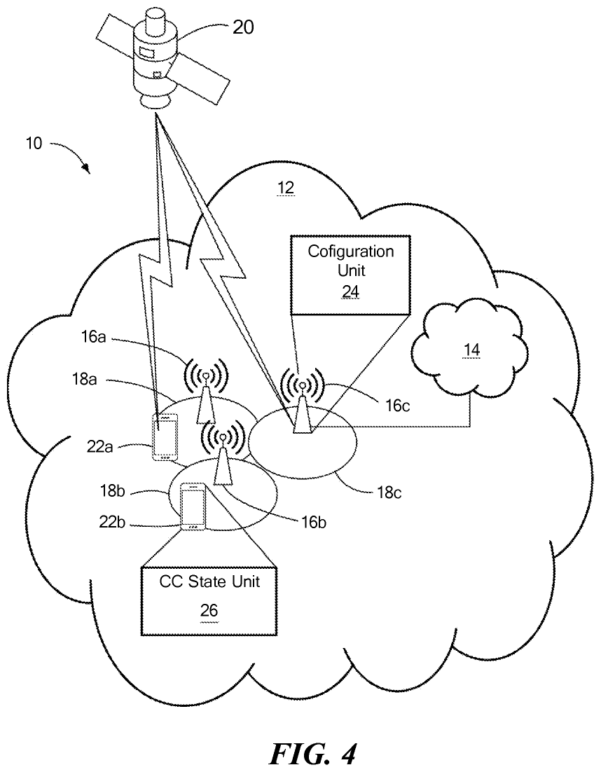

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 15. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. The communication system 10 also includes a constellation of satellites 20 configured to communicate with the network nodes 16 and WDs 22.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

A network node 16 (eNB or gNB) is configured to include a configuration unit 24 which is configured to configure the WD with one of a first cell change procedure state and a second cell change procedure state based at least in part on at least one of a distance between the WD and at least one satellite of the plurality of satellites and a time of coverage of the at least one satellite of the plurality of satellites. A wireless device 22 is configured to include a CC state unit 26 which is configured to perform a first measurement procedure on one or more satellite cells of the plurality of satellite cells when the WD is in a first cell change procedure state and performing a second measurement procedure on one or more satellite cells of the plurality of satellite cells when the WD is in a second cell change procedure state, the first and second cell change procedure states being based at least in part on at least one of a distance between the WD and at least one satellite of the plurality of satellites and a time of coverage of at least one satellite of the plurality of satellites.

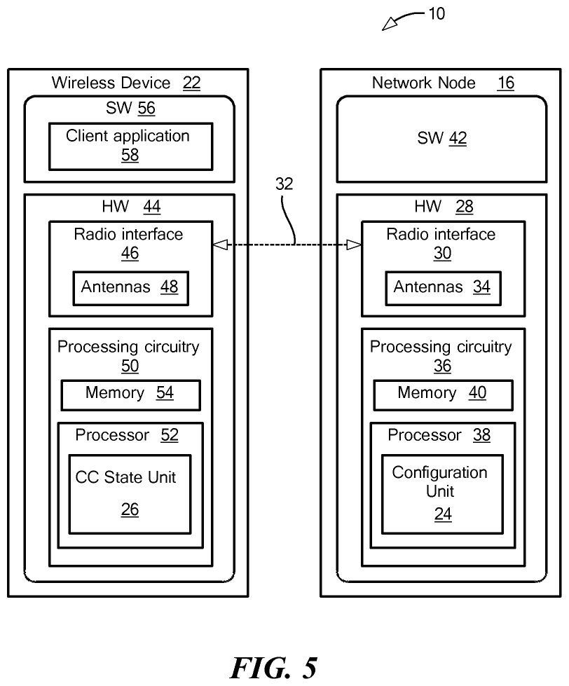

Example implementations, in accordance with an embodiment, of the WD 22 and network node 16 discussed in the preceding paragraphs will now be described with reference to FIG. 5.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include the configuration unit 24 which is configured to configure the WD to enter one of a first state, S1, and a second state, S2, based at least in part on whether a distance between the WD and a serving satellite 20 is below a first threshold, H11, and based at least in part on whether a distance between the WD and a neighbor satellite 20 is above a second threshold, H12.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include the CC state unit 26 which is configured to enter one of a first state, S1, and a second state, S2, based at least in part on whether a distance between the WD and a serving satellite 20 is below a first threshold, H11, and based at least in part on whether a distance between the WD and a neighbor satellite 20 is above a second threshold, H12.

In some embodiments, the inner workings of the network node 16 and WD 22 may be as shown in FIG. 5 and independently, the surrounding network topology may be that of FIG. 4.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 4 and 5 show various “units” such as configuration unit 24 and CC state unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

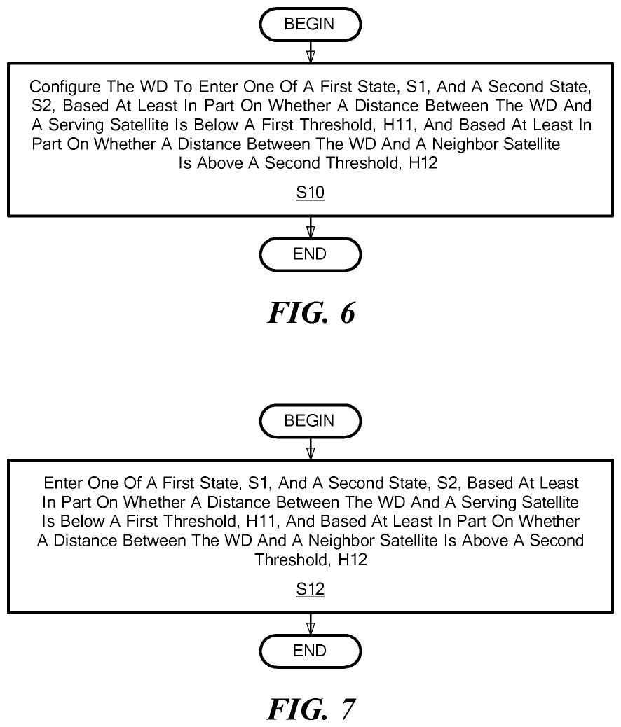

FIG. 6 is a flowchart of an example process in a network node 16 for measurement procedures for conditional cell change in a non-terrestrial network (NTN). One or more blocks described herein may be performed by one or more elements of network node 16 such as by one or more of processing circuitry 36 (including the configuration unit 24), processor 38, and/or radio interface 30. Network node 16 such as via processing circuitry 36 and/or processor 38 and/or radio interface 30 is configured to configuring the WD to enter one of a first state, S1, and a second state, S2, based at least in part on whether a distance between the WD and a serving satellite 20 is below a first threshold, H11, and based at least in part on whether a distance between the WD and a neighbor satellite 20 is above a second threshold, H12. (Block S10).

In some embodiments, the process also includes configuring the WD to perform a first measurement procedure, P1, when the WD is in the first state S1 and to perform a second measurement procedure, P2, when the WD is in the second state. In some embodiments, the first and second measurement procedures are performed according to parameters indicated to the WD. In some embodiments, configuring the WD further includes indicating to the WD whether a configured cell change, CC, procedure is in the S1 state or the S2 state. In some embodiments, the indication to the WD is based at least in part on a time and/or a satellite 20 signal measurement.

FIG. 7 is a flowchart of an example process in a wireless device 22 according to some embodiments of the present disclosure. One or more blocks described herein may be performed by one or more elements of wireless device 22 such as by one or more of processing circuitry 50 (including the CC state unit 26), processor 52, and/or radio interface 46. Wireless device 22 such as via processing circuitry 50 and/or processor 52 and/or radio interface 46 is configured to enter one of a first state, S1, and a second state, S2, based at least in part on whether a distance between the WD and a serving satellite 20 is below a first threshold, H11, and based at least in part on whether a distance between the WD and a neighbor satellite 20 is above a second threshold, H12 (Block S12) In some embodiments, the process also includes performing a first measurement procedure, P1, when the WD is in the first state S1 and performing a second measurement procedure, P2, when the WD is in the second state. In some embodiments, the first and second measurement procedures are performed according to parameters indicated to the WD by the network node. In some embodiments, a state entered by the WD is based at least in part on an indication from the network node indicating whether a configured cell change, CC, procedure is in the S1 state or the S2 state. In some embodiments, the indication to the WD is based at least in part on a time and/or a satellite signal measurement.

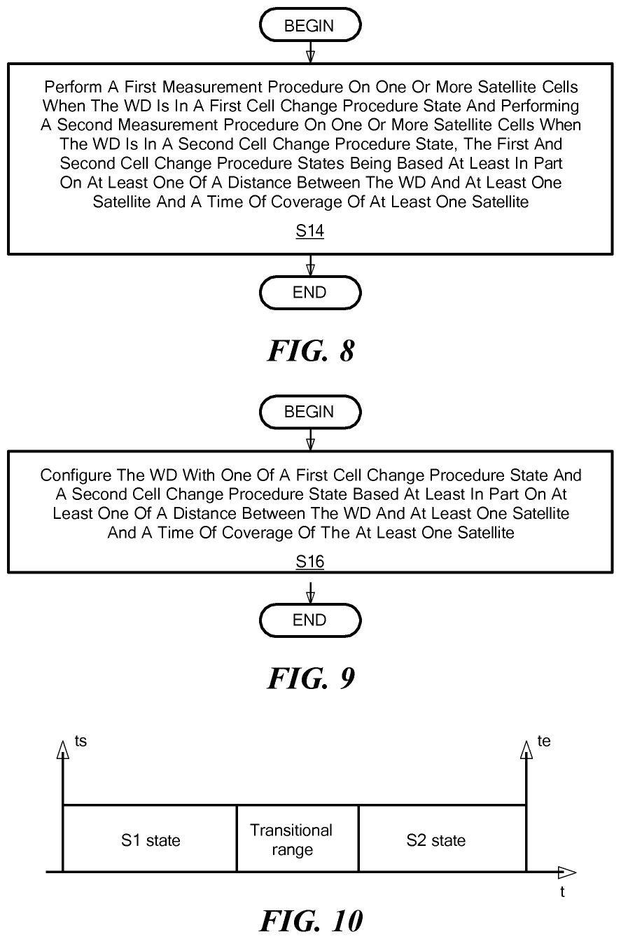

FIG. 8 is a flowchart of an example process in a wireless device 22 according to some embodiments of the present disclosure. One or more blocks described herein may be performed by one or more elements of wireless device 22 such as by one or more of processing circuitry 50 (including the CC state unit 26), processor 52, and/or radio interface 46. Wireless device 22 such as via processing circuitry 50 and/or processor 52 and/or radio interface 46 is configured to perform a first measurement procedure on one or more satellite cells of the plurality of satellite cells when the WD is in a first cell change procedure state and performing a second measurement procedure on one or more satellite cells of the plurality of satellite cells when the WD is in a second cell change procedure state, the first and second cell change procedure states being based at least in part on at least one of a distance between the WD and at least one satellite of the plurality of satellites and a time of coverage of the at least one satellite of the plurality of satellites.

In some embodiments, the first measurement procedure is configured with a first number, periodicity and duration of measurements and the second measurement procedure is configured with a second number, periodicity and duration of measurements. In some embodiments, the first cell change procedure state is configured when a satellite serving cell of the plurality of satellite cells has a first time duration of coverage that exceeds a first threshold and the second cell change procedure state is configured when the satellite serving cell has a second time duration of coverage that falls below a second threshold. In some embodiments, the first cell change procedure state is configured when at least one of a first distance between the WD and a first satellite of the plurality of satellites falls below a first threshold and a second distance between the WD and a second satellite of the plurality of satellites exceeds a second threshold; and the second cell change procedure state is configured when at least one of a first distance between the WD and a first satellite of the plurality of satellites exceeds a first threshold and a second distance between the WD and a second satellite of the plurality of satellites falls below a second threshold. In some embodiments, the method also includes receiving from the network node an indication of one of the first cell change procedure state and the second cell change procedure state. In some embodiments, the method also includes measuring a satellite signal of a satellite of the plurality of satellites and selecting one of the first measurement procedure and the second measurement procedure based at least in part on the measurement of the satellite signal. In some embodiments, the method includes indicating to the network node a capability to support the first and second cell change procedure states. In some embodiments, the first cell change procedure state is configured for a first time duration and the second cell change procedure state is configured for a second time duration at a later time than the first time duration. In some embodiments, the method includes performing a cell change from a first satellite cell of the plurality of satellite cells to a second satellite cell of the plurality of satellite cells during the second time duration. In some embodiments, the method includes performing a cell change from a first satellite cell of the plurality of satellite cells to a second satellite cell of the plurality of satellite cells during the first time duration. In some embodiments, the cell change includes one or more of: a cell reselection, a handover, a conditional cell change, a conditional handover and a conditional radio resource control, RRC, connection release with redirection.

FIG. 9 is a flowchart of an example process in a network node 16 for measurement procedures for conditional cell change in a non-terrestrial network (NTN). One or more blocks described herein may be performed by one or more elements of network node 16 such as by one or more of processing circuitry 36 (including the configuration unit 24), processor 38, and/or radio interface 30. Network node 16 such as via processing circuitry 36 and/or processor 38 and/or radio interface 30 is configured to configure the WD with one of a first cell change procedure state and a second cell change procedure state based at least in part on at least one of a distance between the WD and at least one satellite of the plurality of satellites and a time of coverage of the at least one satellite of the plurality of satellites.

In some embodiments, the method includes configuring the WD to perform a first measurement procedure in the first cell change procedure state and to perform a second measurement procedure in the second cell change procedure state. In some embodiments, the first cell change procedure state is configured when a satellite serving cell of the plurality of satellite cells has a first time duration of coverage that exceeds a first threshold and the second cell change procedure state is configured when the satellite serving cell has a second time duration of coverage that falls below a second threshold. In some embodiments, the first cell change procedure state is configured when at least one of a first distance between the WD and a first satellite of the plurality of satellites falls below a first threshold and a second distance between the WD and a second satellite of the plurality of satellites exceeds a second threshold; and the second cell change procedure state is configured when at least one of a first distance between the WD and a first satellite of the plurality of satellites exceeds a first threshold and a second distance between the WD and a second satellite of the plurality of satellites falls below a second threshold. In some embodiments, the method includes configuring the WD with the first threshold and the second threshold. In some embodiments, the method includes configuring the first cell change procedure state for a first time duration and configured the second cell change procedure state for a second time duration at a later time than the first time duration. In some embodiments, the cell change includes one or more of: a cell reselection, a handover, a conditional cell change, a conditional handover and a conditional RRC connection release with redirection.

Having described the general process flow of arrangements of the disclosure and having provided examples of hardware and software arrangements for implementing the processes and functions of the disclosure, the sections below provide details and examples of arrangements for measurement procedures for conditional cell change in a non-terrestrial network (NTN).

With reference to FIG. 10, there are various timing definitions in different CC cases that may not be fixed. Common fundamental standpoints may be generalized as:
1. CC procedure starts from Ts;
2. CC procedure starts not later than Te; and/or
3. During (Te-Ts), the procedure at any time may be in either of the two states (the S1 state and the S2 state) and switches from one state to the other state

In one example, Te is the expiring time of the serving cell and Ts is the time when the neighbor cell starts to cover the area where the WD 22 is located. The CC procedure starts with in state S1 when Ts is reached and after a certain time passes, the CC procedure enters state S2 once a specified amount of time is left before Te.

In another example, Te is an expiring time of the serving cell and Ts is the time determined by the WD 22 based on Te. The CC procedure starts in S1 when Ts is reached and after a certain time passes, enters S2 once a specified amount of time is left before Te.

In another example, Ts is the time determined by the WD 22 and Ts is later than the time when the neighbor cell starts to cover the area of the WD 22 location. The CC procedure starts with S2 state upon reaching Ts.

Below are some examples which correspond to detailed CC procedures, e.g., CHO and reselections with time or location assistance information.

### Time-Based Cell Change. e.g., CHO

Some embodiments are described with relation to a particular example of the conditional handover (CHO), but are applicable to any type of conditional cell change (CCC) to a target cell. Examples of CCC are CHO, conditional radio resource control (RRC) release with redirection, etc.

The WD 22 may perform a conditional cell change (CCC) (e.g., conditional handover (CHO)) to a target cell only during a certain time window, provided that one or more conditions for executing the CCC are met. Examples of such conditions may include measurement conditions. For example, conditions on reference signal received power (RSRP) and/or reference signal received quality (RSRQ) (if configured for the same candidate target cell) are fulfilled during this time window. For example, the condition may be fulfilled if RSRP and/or RSRQ for the target cell are above their respective thresholds. In yet another example, the CCC may be allowed provided that CCC is triggered for only one candidate target cell during the time window. The time window may be associated with a group of target cells for the CCC. In one example the group may comprise one cell.

The time window is defined by at least one time instance, e.g., t1 or t2. In this case in one example, CCC is triggered any time after t1. In another example, CCC is triggered any time after t2. In another example, the time window is defined by two time instances, e.g., t1 and t2.

In this example, t1 may then represent the earliest point in time when the WD 22 may perform CCC (e.g., CHO) to the candidate target cell. This does not have to be the same as when a network node 16 or other node within the cell may be able to know when the cell may be measured. The time t1 may be the earliest time when to perform cell change (e.g., HO) given that other conditions are fulfilled. The time t2 represents the end of the time window, i.e., the latest point in time when the WD 22 performs CCC (e.g., CHO) to the candidate target cell.

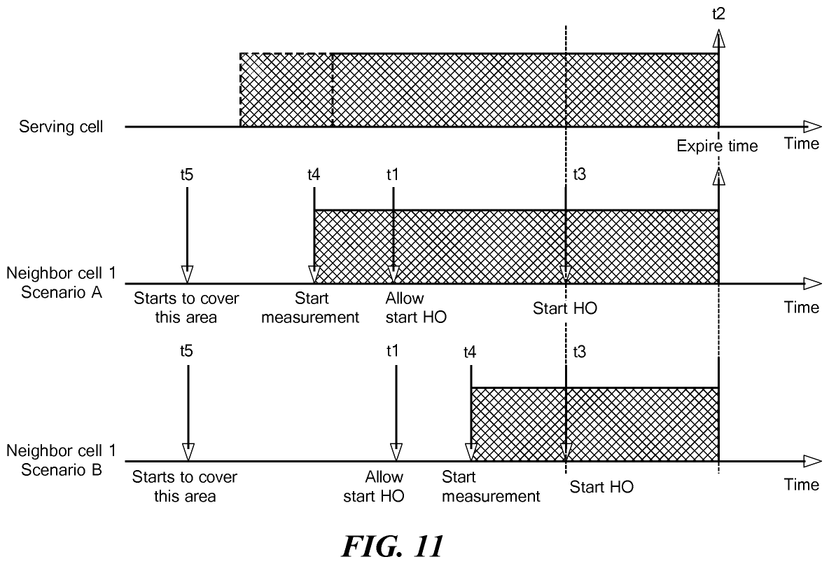

Following definition of t1 and t2, a timeline of time-based CHO is given in FIG. 11 as an example to illustrate the timing.

When the WD 22 is able to execute the CHO between t1 and t2, there are more time points from a measurement point of view, e.g., t1 is equal to a certain threshold (Ht11) to provide service before it expires.

A time t5 is when the neighbor cell starts to cover the area where the WD 22 is located, i.e., which may be identified by the WD 22. A time t4 is when the WD 22 starts measurement determined by the WD 22. A time t3 is when the WD 22 starts CHO.

Let Δt indicate a reserved time interval for margin or headroom due to any measurement error. Then, +/−Δt may be added to one or more of the following time boundaries: [t4, t1] may be [t4, t1] or [t4+/−Δt4, t1+/−Δt1] an so on:
In one example, Ts=t4 and Te=t2 for Scenario A in FIG. 22;
   S1 state is valid, e.g., [t4, t1];
   S2 state is valid in [t1, t2]; and/or
In another example, Ts=t4 and Te=t2 for Scenario B in FIG. 22;
   In one example, S2 state is valid in [t4, t2], where t2−t4 should be at least longer than the time needed to operate measurement and processing procedure for HO before coverage by the serving cell expires.

### Location-Based CHO

Regarding location-based CHO, a CHO location trigger is defined as the distance between the WD 22 and a reference location which may be configured as the serving cell reference location, the candidate target cell reference location, or a combination of serving cell reference location and candidate target cell reference location

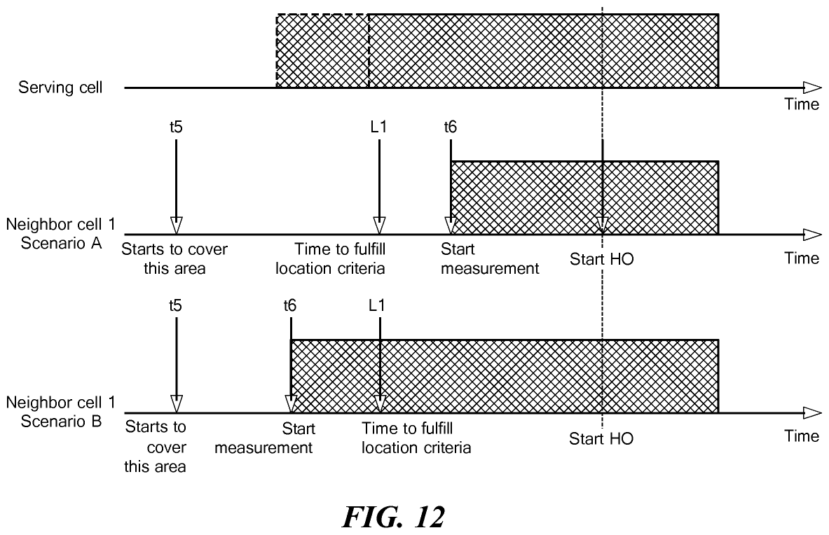

A timeline of location-based CHO is given in FIG. 12 as an example to illustrate the timing. In some embodiments, when the CHO should be completed does not impact operation.

L1 indicates the threshold to trigger location with one or combination criteria, e.g., when the distance with respect to a serving satellite 20 is >H11, and/or the distance with respect to the neighbor satellite 20 is <=H12.

The time t6 is when the WD 22 starts measurement as determined by the WD 22, which may be time or a location which implies a time:
In one example, Ts=t6 for Scenario A in FIG. 12;
In one example, S2 state is valid in from t6 to end of CHO;
In another example, Ts=t6 for Scenario B in FIG. 12;
S1 state is valid in [t6, L1];
S2 state is valid from L1 to end of CHO; and/or
Even it isn't defined explicitly, the time that starts from t6 to the time of expiration of the service by the serving cell should be at least longer than the time needed to operate measurement and processing procedure for HO.

### Time-Based Reselection

A new neighbor cell may start covering the same area before the previous serving cell is switched off. In this scenario, the new cell starts to cover the same area as the serving cell at time t5 and the serving cell is switched off at time t3, e.g., time t5 is equal to the first threshold (Ht11) to provide service before it expires. The WD 22 is expected to start measurements before t5 or within [t5, t3] so that a new or other suitable neighbor cell may be selected before the serving cell is switched off at t3.

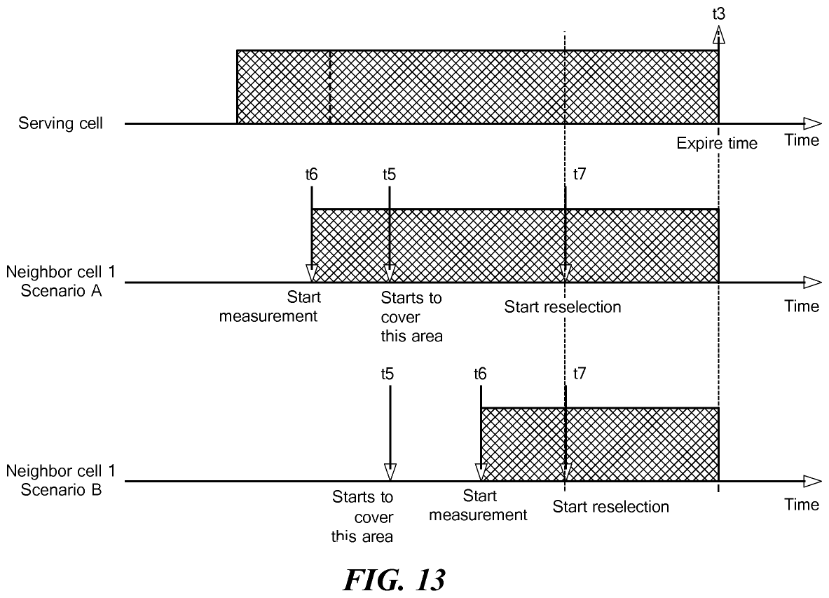

A timeline of location-based reselection is shown in FIG. 13 as an example to illustrate the timing:
In one example, Ts=t6 and Te=t3 for Scenario A in FIG. 13;
   S1 state is valid in [t6, t5];
   S2 state is valid in [t5, t3];
In another example, Ts=t6 and Te=t3 for Scenario B in FIG. 13;
   In one example, S2 state is valid in [t6, t3]; and/or
t3-t5 should be at least longer than the time needed to operate measurement and processing procedure for reselection.

### Location-Based Reselection

Regarding location-based reselection, a location trigger may be defined as the distance between the WD 22 and a reference location, which may be configured as the serving cell reference location or the candidate target cell reference location.

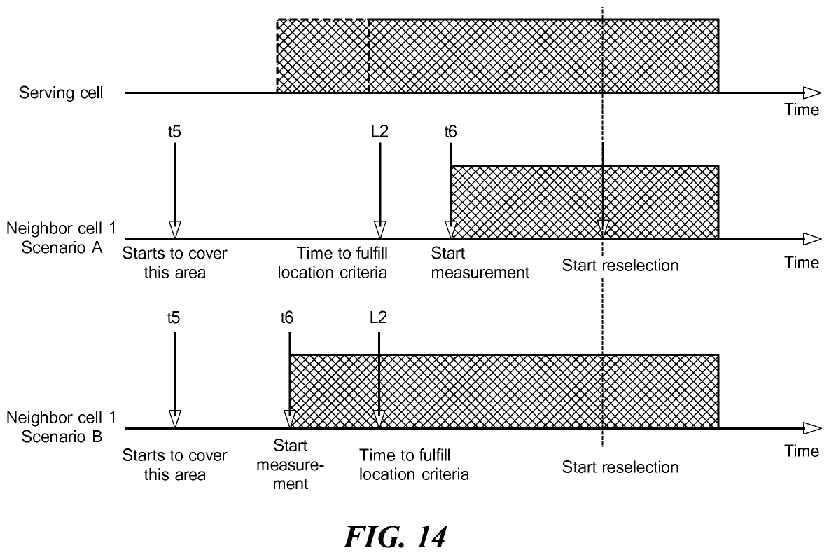

A timeline of location-based reselection is given in FIG. 14 as an example to illustrate the timing. When reselection should be completed is not impacted in the implementation of some embodiments,

L2 indicates a threshold to trigger a location trigger with one or a combination of criteria, e.g., when distance with respect to a serving satellite 20 is >H11, and/or distance with respect to a neighbor satellite 20 is <=H12. Time t6 is the time when the WD 22 starts measurement determined by the WD 22. Time t6 may be a time or a location which implies a time:
In one example, Ts=t6 for Scenario A in FIG. 14
   S2 state is valid in from t6 to end of reselection;
In one example, Ts=t6 for Scenario B in FIG. 14
   S1 state is valid in [t6, L2];
   S2 state is valid in from L2 to end of reselection; and/or
If not explicitly defined, the time that starts from t6 to the expire of serving cell coverage should be at least longer than the time needed to operate a measurements and processing procedure for HO.

In view of the above-described problem, in order to conserve WD 22 power (e.g., energy, battery life etc) and/or avoid or minimize signaling overhead and/or minimize interruption due to link changes, (e.g., interruptions due to cell change (e.g., HO), BM (e.g., beam changes), etc.), and/or speed up mobility in RRC_IDLE/INACTIVE and RRC_CONNECTED states, an adaptive WD 22 measurement procedure may be employed in some embodiments. A method in the WD 22 may include adapting the operation of one or more signals with respect to the different states, e.g., S1 and S2.

Operation of a signal may include transmission of the signal by the WD 22 and/or reception of the signal at the WD 22. Operating a signal may include the WD 22 transmitting the signal and/or receiving the signal. The reception of a signal may also be called monitoring a signal, measuring a signal, etc.

In one example, the measurement adaptation or adaptive measurement or adaptive measurement procedure enables the WD 22, to not only maintain the connection with satellite 20, e.g., measurement on the serving cell, but also enables measurement on signals with different rates and/or periodicities and/or over different time periods and/or measurement numbers in one MO/frequency layer and/or a total number of carriers/frequencies/cells to be measured in a certain RRC state, e.g., in RRC IDLE and RRC INACTIVE procedures.

In another example, the monitoring adaptation or adaptive monitoring or adaptive monitoring procedure enables the WD 22 to monitor a downlink control channel, (e.g., for example for paging, acquiring system information, etc.), while maintaining the connection with satellite 20, more or less frequently.

The measurement adaptation may be applied by the WD 22 by signaling of S1, S2 states by network node 16 and/or evaluation of S1, S2 states at the WD 22.

### WD Measurement Procedures in S1 State and S2 State

The WD 22 in the S1 state may operate signals between the WD 22 and a satellite 20 according to a legacy measurement procedure or legacy procedure or legacy operating procedure. The legacy procedure is called herein a first procedure or first measurement procedure (P1). The WD 22, when operating signals based on the first procedure, should meet reference requirements. The reference requirements may also be called legacy requirements, e.g., performing measurement, acquiring system information (SI), paging, etc., while meeting reference requirements.

The WD 22 in the S2 state operates signals between the WD 22 and a satellite 20 according to an enhanced measurement procedure or faster procedure. The high priority or enhancement procedure is called herein a second procedure or a second measurement procedure (P2). The WD 22 when operating signals based on the second procedure meets high priority or enhancement requirements.

Examples of requirements are measurement time, measurement accuracy, number of identified cells to measure per carrier, number of beams (e.g., SSBs) to measure, etc. Examples of measurement time are cell detection time, measurement period of a measurement (e.g., SS-RSRP, SS-RSRQ, SS signal to interference plus noise (SS-SINR), etc.), SSB index acquisition time, measurement reporting delay, radio link monitoring (RLM) evaluation period (e.g., out of synchronization evaluation period, in synchronization evaluation period, beam detection evaluation period, candidate beam detection evaluation period, measurement period of L1-measurement (e.g., L1-RSRP, L1-SINR, etc.), SMTC number in one MO/frequency layer, number of carriers/frequencies/cells to be measured, etc.

One example of mapping between state and measurement procedures is shown in Table 2

TABLE 2

| | State S1 | State S2 |
|---|---|---|
| measurement procedure in | P1 | P2 |
| carriers/frequencies/cells | | |
| x1, y1, z1 . . . | | |
| measurement procedure in | P1 | P2 |
| carriers/frequencies/cells | | |
| x2, y2, z2 . . . | | |

In state S1 or S2, P1 or P2 per carriers/frequencies/cells, i.e., mapping between all states and all measurement procedures may be pre-defined or configured by the network node 16.

In some embodiments, measurement procedure (P2) in carriers/frequencies/cells x1, y1, z1 . . . and measurement procedure (P1) in carriers/frequencies/cells x2, y2, z2 . . . implies carriers/frequencies/cells x1, y1, z1 . . . have high priority and carriers/frequencies/cells x2, y2, z2 . . . have low priority.

In some embodiments, state and measurement procedure are not limited to 2 categories, e.g., there may be more than one state to implement one measurement procedure, or one state may implement more than one measurement procedure.

A difference between the WD 22 measurement procedures with P1 and P2 configurations are described with several examples below:
In P2, the WD 22 performs fasters measurements on one or more neighbor cells (or carriers, frequencies) than in P1;
   In one example, the WD 22 measures fewer neighbor cells than in P1;
   In another example, the number of SMTCs is fewer than in P1;
   In another example, the number of measurement gaps is fewer than P1;
   In another example, the number of beams (e.g., SSBs) is fewer than P1;
   In another example, if the WD 22 is in discontinuous reception (DRX) and if DT<threshold (H), then the WD 22 measures on one or more target/neighbor cells over non-DRX period; and/or
In P2, the WD 22 doesn't perform or simplify some serving cell procedures than in P1, in order to prioritize measurements on neighbor cells; and/or
In P2, the WD 22 is allowed to perform measurements according to one or more of the following mode of operations:
   The WD 22 performs measurements while meeting shorter requirements e.g., shorter measurement time (Tms) than a reference measurement time (Tmr), e.g., Tme<Tmr. In one example K*Tms=Tmr; where K>1. In another example Tms=400 ms while Tmr=1600 ms for the same measurement, e.g., SS-RSRP;
   The WD 22 performs measurements frequently on some carriers/frequencies/cells than in P1; the WD 22 performs measurements less frequently (or non-measurements) on some other carriers/frequencies/cells than in P1;
   The WD 22 performs measurements over a shorter period of time than in P1;
   The WD 22 performs measurements on fewer reference signals than in P1; and/or
   A scaling factor used by measurements, e.g., RSRP is smaller than in P1.

In general, the measurement P2 performed by the WD 22 which is shorter or less than the requirements met by the WD 22 for the measurement P1 performed, this may speed up or enhance the measurement procedures for, e.g., reselection and CHO.

### Transitional Range Between S1 State and S2 State

If a measurement is ongoing when the WD 22 decides to switch between S1 state and S2 state, there are at least several approaches to handle the transition impact to ongoing measurement.

The measurement period (Tme) when the WD 22 transitions or changes states between the S1 state and the S2 state during the measurement period, may be expressed by the following function:

Tme=f(a,Tm1,Tm2,N)

where:
Tm1 is the measurement period for SMTC1 in S1 state assuming that SMTC does not change during the measurement period;
Tm2 is the measurement period for SMTC2 in S2 state assuming that SMTC does not change during the measurement period;
a is the time required to change the state. In one example, a=0. In another example, a>0; and
N is the number of times the state changes during Tme.

Examples of the function are minimum, maximum, product, sum, difference, average, ceiling, floor, xth percentile, or a combination of 2 or more functions.

In one specific example of the function, Tme may be expressed as follows:

$$Tme = max ( Tm 1 , Tm 2 ) + N * a .$$

In another example of the function, Tme may be expressed as follows:

$$Tme = T m 1 + Tm 2 + N * a .$$

### Method in Network of Controlling WD Measurement States

In some embodiments, the switch between the S1 state and the S2 state mentioned in the above embodiment may be permitted by the network.

For example, the network node 16 (e.g., a serving network node 16 such as gNB) may decide whether to enable the WD 22 in multi-state directly by explicit signaling e.g., RRC, downlink control information (DCI) or medium access control (MAC) control element (CE), because a state may be impacted by conditional handover (CHO) reselection characteristics. For example, a more frequent change of serving satellite 20 may bring shorter coverage time of a satellite 20. The network may decide to enable the possibility of the S1 and S2 states based on system information including location, time and signal strength/quality.

In another example, the network node 16 may indicate enough information on time and location to WD 22 to allow the WD 22 to enter the S1 and S2 states.

In another example, the network node 16 does not indicate enough information on time and location to the WD 22. Then, the WD 22 may be allowed to enter the S1 and S2 state based on evaluation by the WD 22 of, for example, signal strength or quality of the serving cell and/or neighbor cells. Otherwise the WD 22 is not allowed to enter the S1 and S2, in this example.

In another example, the WD 22 may indicate to the network node 16 the capacity to support S1/S2 and/or exact parameters in P1/P2.

Some embodiments may include one or more of the following:

Embodiment A1. A network node configured to communicate with a wireless device (WD), the network node configured to, and/or comprising a radio interface and/or comprising processing circuitry configured to:
configure the WD to enter one of a first state, S1, and a second state, S2, based at least in part on whether a first distance between the WD and a serving satellite is below a first threshold, H11, and based at least in part on whether a second distance between the WD and a neighbor satellite is above a second threshold, H12.

Embodiment A2. The network node of Embodiment A1, wherein the network node and/or radio interface and/or processing circuitry are further configured to configure the WD to perform a first measurement procedure, P1, when the WD is in the first state S1 and to perform a second measurement procedure, P2, when the WD is in the second state.

Embodiment A3. The network node of Embodiment A2, wherein the first and second measurement procedures are performed according to parameters indicated to the WD.

Embodiment A4. The network node of any of Embodiments A1-A3, wherein configuring the WD further includes indicating to the WD whether a configured cell change, CC, procedure is in the S1 state or the S2 state.

Embodiment A5. The network node of Embodiment A4, wherein the indication to the WD is based at least in part on a time and/or a satellite signal measurement.

Embodiment B1. A method implemented in a network node that is configured to communicate with a wireless device, WD, the method comprising:
configuring the WD to enter one of a first state, S1, and a second state, S2, based at least in part on whether a first distance between the WD and a serving satellite is below a first threshold, H11, and based at least in part on whether a second distance between the WD and a neighbor satellite is above a second threshold, H12.

Embodiment B2. The method of Embodiment B1, further comprising configuring the WD to perform a first measurement procedure, P1, when the WD is in the first S1 and to perform a second measurement procedure, P2, when the WD is in the second state.

Embodiment B3. The method of Embodiment B2, wherein the first and second measurement procedures are performed according to parameters indicated to the WD.

Embodiment B4. The method of any of Embodiments B1-B3, wherein configuring the WD further includes indicating to the WD whether a configured cell change, CC, procedure is in the S1 state or the S2 state.

Embodiment B5. The method of Embodiment B4, wherein the indication to the WD is based at least in part on a time and/or a satellite signal measurement.

Embodiment C1. A wireless device (WD) configured to communicate with a network node, the WD configured to, and/or comprising a radio interface and/or processing circuitry configured to:
enter one of a first state, S1, and a second state, S2, based at least in part on whether a first distance between the WD and a serving satellite is below a first threshold, H11, and based at least in part on whether a second distance between the WD and a neighbor satellite is above a second threshold, H12.

Embodiment C2. The WD of Embodiment C1, wherein the WD and/or radio interface and/or processing circuitry are further configured to perform a first measurement procedure, P1, when the WD is in the first state S1 and to perform a second measurement procedure, P2, when the WD is in the second state.

Embodiment C3. The WD of Embodiment C2, wherein the first and second measurement procedures are performed according to parameters indicated to the WD by the network node.

Embodiment C4. The WD of any of Embodiments C1-C3, wherein a state entered by the WD is based at least in part on an indication from the network node indicating whether a configured cell change, CC, procedure is in the S1 state or the S2 state.

Embodiment C5. The WD of Embodiment C4, wherein the indication to the WD is based at least in part on a time and/or a satellite signal measurement.

Embodiment D1. A method implemented in a wireless device (WD) that is configured to communicate with a network node, the method comprising: entering one of a first state, S1, and a second state, S2, based at least in part on whether a first distance between the WD and a serving satellite is below a first threshold, H11, and based at least in part on whether a second distance between the WD and a neighbor satellite is above a second threshold, H12.

Embodiment D2. The method of Embodiment D1, further comprising performing a first measurement procedure, P1, when the WD is in the first state S1 and performing a second measurement procedure, P2, when the WD is in the second state.

Embodiment D3. The method of Embodiment D2, wherein the first and second measurement procedures are performed according to parameters indicated to the WD by the network node.

Embodiment D4. The method of any of Embodiments D1-D3, wherein a state entered by the WD is based at least in part on an indication from the network node indicating whether a configured cell change, CC, procedure is in the S1 state or the S2 state.

Embodiment D5. The method of Embodiment D4, wherein the indication to the WD is based at least in part on a time and/or a satellite signal measurement.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

### ABBREVIATIONS THAT MAY BE USED IN THE PRECEDING DESCRIPTION INCLUDE

3GPP 3rd Generation Partnership Project
5G 5th Generation
BS Base Station
CHO Conditional Handover
eNB Evolved NodeB (LTE base station)
GEO Geostationary Orbit
gNB Base station in NR.
GNSS Global Navigation Satellite System
HO Handover
LEO Low Earth Orbit
LTE Long Term Evolution
MAC Medium Access Control
NR New Radio
NW Network
NTN Non-Terrestrial Network
RAT Radio Access Technology
RRC Radio Resource Control
RRM Radio Resource Management
RS Reference Signal
RSRP Reference Signal Received Power
SMTC SSB Measurement Timing Configuration
SNR Signal to noise ratio
UE User Equipment
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1-36. (canceled)

37. A method in a wireless device, WD, configured to communicate with a network node and a plurality of satellites on a corresponding plurality of satellite cells, the method comprising:
receiving configuration for a conditional cell change;
determining a measurement procedure on one or more satellite cells of the plurality of satellite cells, determining the measurement procedure comprising selecting a measurement procedure from a first measurement procedure and a second measurement procedure at least based on assistance information, the assistance information comprising an earliest allowable timing for the WD to perform cell change according to the configuration, and selecting the measurement procedure being at least partially based on the earliest allowable timing; and
performing the determined measurement procedure for the conditional cell change.

38. The method according to claim 37, wherein selecting a measurement procedure is further based on a timing when condition to start measurement is satisfied.

39. The method according to claim 37, wherein the earliest allowable timing for the WD to perform cell change is time-based or location-based condition related to the WD.

40. The method according to claim 37, wherein the selecting the measurement procedure is further based on one or both signal strength and quality of a serving satellite cell and a neighbor satellite cell of the WD.

41. The method according to claim 37, wherein the first measurement procedure and the second measurement procedure differ in at least one of:
a number of SMTCs of the second measurement procedure being fewer than that of the first measurement procedure;
a number of neighbor cells measured being fewer than that of the first measurement procedure; or
measurements on neighbor cells are prioritized.

42. The method according to claim 37, wherein the cell change comprises any of:
conditional handover, CHO, cell reselection; and
conditional radio resource control, RRC, connection release with redirection.

43. A wireless device, WD, configured to communicate with a network node and a plurality of satellites on a corresponding plurality of satellite cells, the WD comprising processing circuitry configured to:
receive configuration for a conditional cell change;
determine a measurement procedure on one or more satellite cells of the plurality of satellite cells, determining the measurement procedure comprising selecting a measurement procedure from a first measurement procedure and a second measurement procedure at least based on assistance information, the assistance information comprising an earliest allowable timing for the WD to perform cell change according to the configuration, and selecting the measurement procedure being at least partially based on the earliest allowable timing; and
perform the determined measurement procedure for the conditional cell change.

44. The wireless device according to claim 43, being configured that the selecting the measurement procedure is further based on a timing when condition to start measurement is satisfied.

45. The wireless device according to claim 43, wherein the earliest allowable timing for the WD to perform cell change is time-based or location-based condition related to the WD.

46. The wireless device according to claim 43, being configured that the selecting the measurement procedure is further based on one or both signal strength and quality of a serving satellite cell and a neighbor satellite cell of the WD.

47. The wireless device according to claim 43, wherein the first measurement procedure and the second measurement procedure differ in at least one of:
a number of SMTCs of the second measurement procedure being fewer than that of the first measurement procedure;
a number of neighbor cells measured being fewer than that of the first measurement procedure; or
measurements on neighbor cells are prioritized.

48. The wireless device according to claim 43, wherein the cell change comprises any of:
conditional handover, CHO, cell reselection; and
conditional radio resource control, RRC, connection release with redirection.

49. A method in a network node configured to communicate with a wireless device, WD, the WD being configured to communicate on a least one of a plurality of satellite cells of a corresponding plurality of satellites, the method comprising:
configuring the WD with a conditional cell change, the configuration enabling the WD to obtain earliest allowable timing to perform cell change;
configuring the WD with a first measurement procedure and a second measurement procedure, an earliest allowable timing being a basis for the WD to determining a measurement procedure from the first measurement procedure and the second measurement procedure; and
receiving cell change request from the WD.

50. The method according to claim 49, wherein the configured conditional cell change comprises any of:
conditional handover, CHO, cell reselection; and
conditional radio resource control, RRC, connection release with redirection.

51. The method according to claim 49, wherein the earliest allowable timing for the WD to perform cell change is time-based or location-based condition related to the WD.

52. The method according to claim 49, wherein the first measurement procedure and the second measurement procedure differ in at least one of:
a number of SMTCs of the second measurement procedure being fewer than that of the first measurement procedure;
a number of neighbor cells measured being fewer than that of the first measurement procedure; or
measurements on neighbor cells are prioritized.

53. A network node configured to communicate with a wireless device, WD, the WD being configured to communicate on a least one of a plurality of satellite cells of a corresponding plurality of satellites, the network node comprising processing circuitry configured to:
configure the WD with a conditional cell change, the configuration enabling the WD to obtain earliest allowable timing to perform cell change;
configure the WD with a first measurement procedure and a second measurement procedure, an earliest allowable timing being a basis for the WD to determining a measurement procedure from the first measurement procedure and the second measurement procedure; and
receive cell change request from the WD.

54. The network node according to claim 53, wherein the earliest allowable timing for the WD to perform cell change is time-based or location-based condition related to the WD.

55. The network node according to claim 53, wherein the first measurement procedure and the second measurement procedure differ in at least one of:
a number of SMTCs of the second measurement procedure is fewer than that of the first measurement procedure;
a number of neighbor cells measured is fewer than that of the first measurement procedure; or
measurements on neighbor cells are prioritized.
